(19) United States
(12) Patent Application Publication
(10) Pub. No.: US 2010/0063943 A1
(43) Pub. Date: Mar. 11, 2010

(54) REPRESENTATION OF THE RESULT OF AN INSPECTION STEP IN AN INTELLIGENT DOCUMENT

(75) Inventors: Jürgen Lang, Bergisch Gladbach (DE); Bernd Meyer, Konigswinter (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/447,273

(22) PCT Filed: Oct. 24, 2007
(86) PCT No.: PCT/EP07/09223

§ 371 Date: Apr. 27, 2009

(30) Foreign Application Priority Data
Oct. 27, 2006 (DE) 10 2006 051 418.1

(51) Int. Cl. G06F 17/00; G06F 15/16; G07B 17/02

(52) U.S. Cl. 705/404; 715/234; 709/203; 705/408

(57) ABSTRACT

There is provided a method and system for producing an intelligent document comprising a program which, when a precondition has been met, can be executed by a program execution environment, the intelligent document containing contents that can be displayed by a display program. An exemplary method comprises incorporating a program module into the intelligent document, the program module being configured to create displayable information indicating a result of a checking step in order to check whether the precondition has been met within the intelligent document. The exemplary method also comprises inserting displayable information indicating a negative result of the checking step into the intelligent document. The exemplary method additionally comprises transforming, with the program module, the information indicating the negative result of the checking step into displayable information indicating a positive result of the checking step.

### CROSS REFERENCE TO RELATED APPLICATIONS

Pursuant to 35 U.S.C. §371, this application is the United States National Stage Application of International Patent Application No. PCT/EP2007/009223, filed on Oct. 24, 2007, the contents of which are incorporated by reference as if set forth in their entirety herein, which claims priority to German (DE) Patent Application No. 10 2006 051 418.1, filed Oct. 27, 2006, the contents of which are incorporated by reference as if set forth in their entirety herein.

### BACKGROUND

It is a known procedure from German patent application DE 10 2004 046 051 A1 to use an intelligent document in order to provide postage indicia generated in a central franking server to an operating unit via a network. Intelligent documents contain not only text elements and graphic elements but also a process logic that makes it possible to change the content of the document and to carry out prescribed processes. In particular, in this prior-art method, the printing of a postage indicium contained in such an intelligent document is logged in a central database and, before the printing procedure, it is ascertained whether this postage indicium has already been printed before. If this is the case, the printing is not permitted, thereby preventing multiple printing of the postage indicium with fraudulent intent. The logging of the printing and the checking steps are carried out by the process logic of the intelligent document, said process logic controlling especially the communication between the operating unit and the central database. In order to execute the process logic, a program execution environment is needed that is contained in a display program that is executed in the operating unit of the customer and that is configured in such a way that it can display and interpret regular documents as well as intelligent documents. An example of such a display program is “Adobe Reader” made by the Adobe company, whose more recent versions can process conventional PDF documents (PDF: Portable Document Format) as well as intelligent PDF documents.

In the known method, a postage indicium cannot be printed if certain preconditions for the printing have not been met. Thus, for example, the printing cannot be carried out if the operating unit has a version of the display program that is not capable of interpreting intelligent documents or if an appropriate functionality of the display program is not activated. In these cases, even though static contents of the intelligent document can generally be displayed on the operating unit, the functionality of the document for carrying out the necessary database query and for controlling the printing is not available. Furthermore, the network connection between the operating unit and the network can be deactivated so that it cannot be determined whether the postage indicium has already been printed before. In this case, it is likewise not possible to print the postage indicium.

Here, the problem arises that the user does not receive any information about which precondition for the printing of the postage indicium has not been met, since the results of the checking steps indicating whether the preconditions have been met for the use of the functionality of the intelligent document are not displayed. This greatly reduces the probability that the user can autonomously meet the lacking preconditions on his own. This leads to dissatisfaction on the part of the user and to unnecessary service calls to the provider of the postage indicia.

### SUMMARY OF THE INVENTION

An exemplary embodiment of the present invention may display the result of a checking step in order to check whether a precondition for the use of a functionality of an intelligent document has been met.

Accordingly, a method according to an exemplary embodiment of the present invention relates to an intelligent document that comprises a program which, when a precondition has been met, can be executed using a program execution environment, said intelligent document containing contents that can be displayed using a display program. A program module is incorporated into the intelligent document, said program module being configured to create displayable information indicating the result of the checking step in order to check whether the precondition has been met within the intelligent document.

Moreover, an intelligent document is created comprising a program which, when a precondition has been met, can be executed using a program execution environment, said intelligent document containing contents that can be displayed using a display program. The intelligent document may be characterized in that it contains a program module that is configured to create displayable information indicating the result of the checking step in order to check whether the precondition has been met within the intelligent document.

Moreover, an exemplary device for the production of an intelligent document is put forward comprising a program which, when a precondition has been met, can be executed using a program execution environment and that contains contents that can be displayed using a display program. The device is configured to insert a program module into the intelligent document, said program module being configured to create displayable information indicating the result of the checking step in order to check whether the precondition has been met within the intelligent document.

An advantage of an exemplary embodiment of the present invention lies in the fact that the intelligent document itself contains a program module with which information indicating the result of a checking step can be created. In this manner, the intelligent document itself is capable of providing information indicating the result of a checking step, so that the result of the checking step is displayed irrespective of the configuration of the display program.

Displayable information within an intelligent document may be referred to herein as information that can be displayed, for example, on a monitor using the display program. The intelligent documents can contain not only displayable contents but also additional contents such as, for example, program codes that, at least in a normal display mode, are not shown using a display program.

Within the scope of the checking steps, it is advantageously checked whether certain preconditions have been met for the use of the functionality of the intelligent document. If these preconditions have been met, a positive result of the checking step is displayed. If the preconditions have not been met, a negative checking result is displayed, so that the user is informed as to which precondition has not been met. He or she can use this knowledge to meet the precondition in question.

The method, the intelligent document and the device according to an exemplary embodiment of the present invention may provide that the checking step is carried out using the program module.

In such an exemplary embodiment, the functionality for carrying out the checking step is also advantageously present in the intelligent document itself, so that the intelligent document can check itself, irrespective of the specific configuration of the display program.

A refinement of the method, of the intelligent document and of the device according to an exemplary embodiment of the present invention may be characterized in that, during the checking step, it is checked whether the program execution environment is available.

Such a refinement has the advantage that it entails checking whether the program execution environment is available so that, if applicable, the user can be informed that the program execution environment is not present and thus that certain functions of the intelligent document are not available.

If the program execution environment is not available, however, the checking step cannot be performed directly by the execution of a program. By the same token, the information indicating a negative result of the checking step cannot be inserted into the intelligent document using the program module.

Consequently, a method according to an exemplary embodiment of the present invention may exploit the fact that displayable information indicating a negative result of the checking step may be inserted into the intelligent document, and that the program module may be configured to convert the information indicating the negative result of the checking step into displayable information indicating a positive result of the checking step.

Moreover, an exemplary embodiment of the intelligent document provides that the intelligent document contains displayable information indicating a negative result of the checking step and that said information can be converted by the program module into displayable information indicating a positive result of the checking step.

Furthermore, an exemplary embodiment of the device may be characterized in that the device is configured to insert displayable information indicating a negative result of the checking step into the intelligent document, and in that the program module is configured to convert the displayable information indicating the negative result of the checking step into information indicating a positive result of the checking step.

In such exemplary embodiments, the checking as to whether the program execution environment is present, can advantageously be carried out implicitly by the program module, which creates the information indicating the result of the checking step within the intelligent document. This is achieved in that, through the execution of the program module, which can only occur if the program execution environment is available, information indicating a positive result of the checking step is created by converting information indicating a negative result of the checking step already present in the intelligent document. If the program execution environment is not available, the program module cannot be executed and the information indicating the negative result of the checking step is retained.

The method, the intelligent document and the device according to an exemplary embodiment of the present invention may also be characterized in that the program module is configured to block the display of the displayable information indicating the negative result of the checking step after the intelligent document has been opened.

If the program execution environment is present, then the display of the negative result of the checking step is at first suppressed after the intelligent document has been opened. This has the advantage that negative information about a checking step is not already displayed to the user before the result of the checking step is present.

Moreover, the method, the intelligent document and the device according to an exemplary embodiment of the present invention may be characterized in that the program module is configured to release the display of the displayable information about a result of the checking step once the checking step has been carried out.

Advantageously, the result of the checking step in such an exemplary embodiment is only displayed after the checking step has been carried out, i.e. once the checking result is available.

In a refinement of the method, the intelligent document and the device according to an exemplary embodiment of the present invention, it is provided that the program controls the one-time printing of a postage indicium, and that an intelligent document is transmitted from a franking server via a network to a franking client.

The method, the intelligent document and the device according to an exemplary embodiment of the present invention may also be characterized in that, when the postage indicium is printed for the first time, a message is transmitted from the user client to the franking server and in that, on the basis of this message, the printing is logged in the franking server.

Moreover, in an exemplary embodiment of the method, of the intelligent document and of the device, it may be provided that the program for controlling the printing of the postage indicium can only be executed if a network connection exists between the franking client and the franking server, and if, on the basis of a query to the franking server, it has been ascertained that that postage indicium had not been printed before.

This prevents a postage indicium that has been paid for once from being printed out multiple times.

The method, the intelligent document and the device according to an exemplary embodiment of the present invention may be characterized in that, during the checking step, it is checked whether there is access to the network.

Moreover, a refinement of the method, of the intelligent document and of the device according to an exemplary embodiment of the present invention entails the fact that, during the checking step, a query to the franking server is made in which it is checked whether contents of the intelligent document have already been printed before.

Another exemplary embodiment of the method, of the intelligent document and of the device exploits the fact that the program execution environment is a component of the display program.

Moreover, a computer program product according to an exemplary embodiment of the present invention is provided that contains a computer program for executing a method of the type described above.

The above-mentioned as well as additional advantages, special features and practical refinements of an exemplary embodiment of the present invention are also elucidated on the basis of the embodiments, which are described below making reference to the figures.

### BRIEF DESCRIPTION OF THE DRAWINGS

The figures show the following:

FIG. 1 is a block diagram of a user client that is connected to a server from which intelligent documents can be transmitted to the user client according to an exemplary embodiment of the present invention;

FIG. 2a is a block diagram showing displayable contents of an intelligent document containing information indicating negative results of several checking steps according to an exemplary embodiment of the present invention; and

FIG. 2b is a block diagram showing displayable contents of an intelligent document containing information indicating positive results of several checking steps according to an exemplary embodiment of the present invention.

### DETAILED DESCRIPTION OF SPECIFIC EMBODIMENTS

Exemplary embodiments of the present invention relate to a method for the production of an intelligent document. Exemplary embodiments of the present invention also relate to an intelligent document and to a device for the production of an intelligent document that is suitable for carrying out the method.

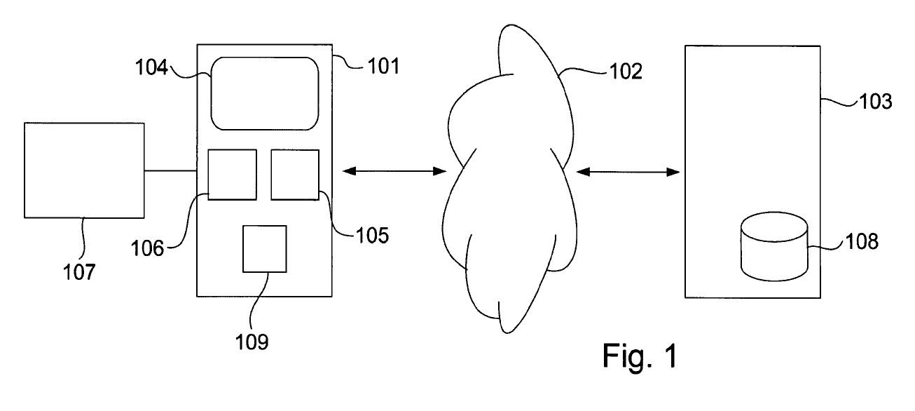

FIG. 1 schematically shows a user client 101 that is connected to a server 103 via a network 102. The network 102 is, for example, the Internet or an intranet. The user client 101 is, for example, a PC (personal computer) that has a display device 104 and at least one input device 109 as well as a memory 105 and a processor 106. In particular, a display program is stored in the memory 105; this program can be executed in the user client 101 and it can open conventional documents having a certain format such as, for example, PDF documents, and can display their contents on the display device 104. Moreover, the display program allows the processing of intelligent documents, that is to say, it is configured to display displayable contents of intelligent documents on the display device 104, and to execute programs that are contained in the intelligent documents. For this purpose, the display program provides a program execution environment with which program commands contained in the programs can be interpreted and executed. Moreover, the user client 101 is connected to a printing device 107 via an interface and it has a network interface for purposes of connecting to the network 102.

Intelligent documents are transmitted from the server 103 via the network 102 to the user client 101. For this purpose, the server 103 has a means configured, for example, as a software program, in order to create intelligent documents. In an exemplary embodiment, the server 103 is configured as a franking server that provides intelligent documents for the printing of postage indicia. In this exemplary embodiment, the server 103 comprises a database 108 with one entry for each postage indicium that has been generated and transmitted to a user client 101.

The intelligent documents comprise contents that can be displayed on the display device 104 by the display program and that consist of text elements and/or graphic elements. Furthermore, programs that can be executed by the program execution environment are embedded into the intelligent documents. These programs are scripts that comprise a program code that can be interpreted by the program execution environment. Displayable contents of the intelligent documents can be changed using the programs. Moreover, the programs allow the execution of additional processes such as, for example, the actuation of the printing device 107 for printing contents of the intelligent document, or for accessing the network interface. In the normal display mode of the display program, the program code is not displayed on the display device 104. Fundamentally, however, the display program can have a special display mode in which the program code can also be displayed.

Within the scope of an exemplary embodiment of the present invention, an intelligent document provided by the server 103 also contains status information indicating the result of one or more checking steps. Here, displayable information indicating the checking results is created by one or more program modules that are likewise contained in the intelligent document. The program modules can be configured as autonomous programs or they can be part of a program that is provided for the execution of the main functionality of the intelligent document. Within the scope of the checking steps, it is ascertained whether certain preconditions for the use of the main functionalities of the intelligent document have been met. In this manner, in the eventuality of an unusable functionality, the user especially is informed about a precondition that might not have been met. He or she can use this knowledge to meet the precondition and thus to use the functionality of the intelligent document.

A precondition for the use of the functionality of an intelligent document is the availability of the program execution environment. As a rule, however, not all display programs for displaying documents in the format of the intelligent document have a suitable program execution environment. Thus, the program execution environment might not be present, for example, in older versions of the display program. In these versions, only the displayable contents present in the intelligent document can be displayed and/or printed. Therefore, in an exemplary embodiment, a checking step especially checks whether the display program of the user client 101 has a program execution environment that is suitable for executing the program contained in the intelligent document. In order to be able to correctly display the result of this checking step even if the program execution environment is not present, displayable information indicating a negative result of the checking step is already inserted into the document at the time when the intelligent document is created. Furthermore, a program module is inserted into the intelligent document and this program module—when it is executed—converts information indicating the negative result of the checking step into information indicating a successful execution of the checking step. The intelligent document is preferably configured in such a way that, after said intelligent document has been opened in the display program, the program module is automatically started if the program execution environment is present. In one exemplary embodiment, after the intelligent document has been opened in the display program, the information indicating the negative checking result is displayed, irrespective of whether the program execution environment is available or not. In another exemplary embodiment, the display of the negative checking result is blocked by the program module after the opening, if it can be executed. If this is not the case because of the absence of the program execution environment, the negative checking result is displayed after the opening in this embodiment as well.

If the program execution environment is available, the program module is started after the intelligent document has been opened. On the basis of the execution of the program, the information indicating the negative result of the checking step, i.e. the information indicating that the program execution environment is not available, is converted into information indicating a positive result of the checking step. If the program execution environment is not available, the program module cannot be executed, and the information indicating the negative result of the checking step is retained in unchanged form. Checking whether the program execution environment is available is thus carried out implicitly, and this yields a positive or negative result, depending on whether the program module can be executed or not. After the information indicating the negative checking result has been converted into information indicating a positive checking result, this is displayed on the display device 104. If the display of the information indicating the negative result of the checking step has been blocked after the intelligent document has been opened, then the display of the information indicating the (positive) checking result for this is released by the program module.

The conversion of the information indicating the negative result of the checking step into the display of a positive result of the checking step can be done by changing the information. For example, one or more characters can be added to the negative information in order to create information indicating a positive result of the checking step. Moreover, the status information can be configured, for example, to be colored. The information indicating the negative result of the checking step can be converted into information indicating a positive result by a color change that is effectuated by the program. Furthermore, it can also be provided that characters or symbols of the information indicating the negative result of the checking result are at least partially replaced by characters or symbols such that a positive result of the checking step is displayed.

In addition to this checking step, in which a decision is made about the presence of the program execution environment, by the same token, other checking steps can be executed by a program contained in the intelligent document, if the program execution environment is available. The results of these checking steps can then be displayed in the same manner in that, by a program module, information indicating a negative result is converted into information indicating a positive result. The display of the information indicating the negative result of the checking step can likewise be blocked until these checking steps have been carried out. Since these checking steps can only be carried out if the program execution environment is present, it is also possible for these checking steps to dispense with first incorporating negative information indicating the checking result into the document. The displayable information indicating the result of the checking steps can be generated by the appropriate program modules after the checking steps have been carried out. Depending on the checking result, information indicating a negative or a positive checking result is generated. In particular, the intelligent document in this embodiment can first contain neutral information about the checking result, which is then converted into information indicating a positive or negative checking result, depending on the result of the checking step.

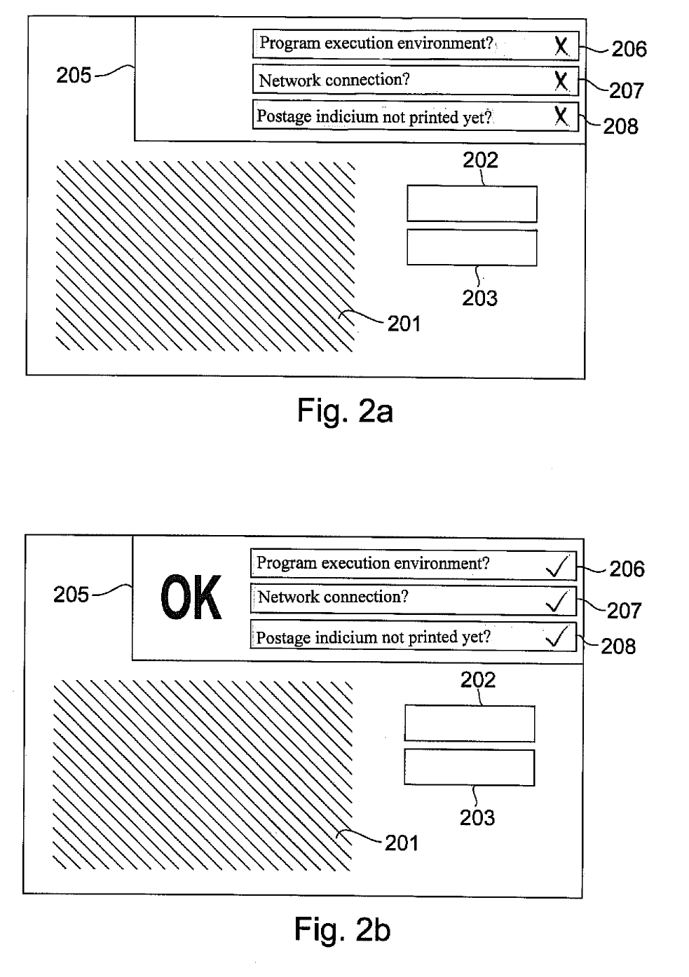

FIG. 2a shows by way of an example a display of contents of an intelligent document on the display device 104 of a user client 101. The intelligent document allows one-time printing of a postage indicium that can contain cryptographically secured data that allows its authenticity to be checked. The intelligent document comprises a main area 201 around which, for example, a sample of the postage indicium or of a franking label containing the postage indicium can be displayed. The sample can be printed as often as desired. For this purpose, the intelligent document provides a button 202 that is linked to a program that controls the sample printing and that is contained in the intelligent document. Moreover, the intelligent document contains another button 203 whose actuation triggers the printing of the valid postage indicium. The button 203 is linked to a program that controls the printing of the valid postage indicium and that is executed when the button is actuated. The buttons 202, 203 can be actuated by the operator of the user client 101 using the input device 109. The printing of the valid postage indicium is logged, whereby the logging is controlled or triggered by a program of the intelligent document. In this context, the actuation of the button 203 causes the program to trigger the transmission of a message about the printing to the server 103 in whose database 108—after receipt of the message has been received—an appertaining record of the printing is added to the data record that is associated with the postage indicium. Preferably, an unambiguous identification code is associated with the postage indicium, and said identification code serves especially to identify the database entry and is also contained in the message. In order to prevent multiple printing of the postage indicium, before the activation of the button 203, a query to the database of the server takes place in order to ascertain whether the record of the printing is present. Moreover, the postage indicium cannot be displayed on the display device 104 in order to prevent copies of the display from being generated and used for franking mailpieces. This is achieved in an exemplary embodiment of the present invention in that the postage indicium is contained in a concealed area of the intelligent document that cannot be displayed by the display program. In another embodiment, it is provided that the valid postage indicium is only called by the server 103 once the button 203 has been actuated for printing the postage.

In order to be able to print a postage indicium, it is thus especially necessary that
the display program has a program execution environment for executing programs that are embedded in the intelligent document,
the user client 101 is connected to the network 102 and the programs can to access said connection and
the database does not contain a record of the printing of the postage indicium.

Therefore, preferably when the intelligent document is opened, checking steps are executed in which it is checked whether the above-mentioned preconditions have been met. The results of these checking steps are displayed in the intelligent document in a status display 205. The depicted status display contains a status field 206 for the information indicating the result of the checking as to whether the program execution environment is available, it contains a status field 207 for the information indicating the result of the checking as to whether a network connection exists, and it also contains a status field for the information indicating the result of the checking as to whether the postage indicium was already printed before. At first, the intelligent document provided by the server 103 contains the status display schematically shown in FIG. 2a, which comprises at least the information indicating a negative result of the first checking step in which the presence of the program execution environment is checked. The results of the other checking steps—in which the connection of the client 101 to the network 102 and the presence of the record of the printing in the database of the server 103 are checked—are preferably likewise displayed negatively. Fundamentally, this information can also be inserted into the document in neutral form and, after the execution of the checking steps, it can be converted into a positive or negative checking result, depending on the outcome. However, the fact that, at first, information indicating negative checking results is present in the document, especially has the advantage that the status information indicating these checking steps behaves in the same manner as the information indicating the results of the checking as to whether the program execution environment is present. This checking result cannot be inserted into the document in neutral form and converted after the checking has been completed, since the absence of the program execution environment would not allow a conversion in the case of a failure of the checking. In the embodiment of the status display, which is shown in FIG. 2a, the negative result of a checking step is displayed by an “X” inside the status fields 206, 207, 208.

After the intelligent document has been opened in the display program of the user client 101, the checking steps are executed consecutively. After the successful execution of the checking steps, the appertaining information indicating the negative checking result is converted in the status display 205 into information indicating positive checking results. Moreover, after the successful execution of a checking step, the next checking step is started. In particular, the intelligent document contains a program module with which, as already described above, the information indicating the negative result of the checking that is contained in the status field 206 as to whether the program execution environment is present is converted into a positive checking result. Using the program module, the information indicating the negative result of the checking can at first be suppressed after the intelligent document has been opened. After the information indicating the negative checking result has been converted into information indicating a positive checking result, the display of the information is then released. After the checking has been successful as to whether the program execution environment is present, using the same program module or another program module, it is ascertained whether access to the network 102 exists in that, for example, a query is sent to the server 103. If a response to this query is received, the network connection exists, and the appertaining information in the status field 207 is converted into information indicating a positive result of the checking step or else the information indicating the positive result of the checking step is generated. Furthermore, the database 108 of the server 103 is queried via the network 102 by a program module present in the intelligent document in order to ascertain whether the postage indicium has already been printed out before. If this is not the case, then the appertaining information in the status field 208 is converted into information indicating a positive result of the checking step or the information indicating the positive result of the checking step is generated. Moreover, the button 203 for initiating the printing of the valid postage indicium pops up or is activated in such a way that it can be actuated by the user.

By way of an example, FIG. 2b shows information indicating the positive results of the checking steps within the status display 205 of the intelligent document already presented in FIG. 2a. Here, by way of an example, the Xs shown in the status fields 206, 207, 208 have been replaced with checkmarks in order to indicate the positive checking results. Furthermore, in the shown embodiment of the intelligent document, it is provided that the successful execution of all checking steps is indicated by the letters “OK” which are likewise inserted by a program into the intelligent document as displayable content once the last checking step has been successfully executed.

If a checking step could not be executed successfully, then information indicating the negative result of the applicable checking step is displayed. If this information had already been incorporated into the intelligent document when the negative result was created and if the display of this information had been suppressed until the applicable checking step had been carried out, then the display of the information indicating the negative checking result is released, if it is present. The subsequent checking steps are preferably no longer executed. On the basis of a displayed negative result of a certain checking step, the user is informed about the absence of a precondition for the franking of a mailpiece by the intelligent document. Thus, the user is given the possibility to take measures in order to meet the appertaining preconditions. In the case of information indicating a negative result of the checking as to whether the program execution environment is available, the user can install, for example, a version of the display program on the user client 101 containing the program execution environment. In the case of information indicating a negative result of the checking as to whether a network connection is present, the user can, for example, activate the network connection. If a negative result of the checking as to whether the postage indicium has already been printed out before is displayed, then the user knows that he or she cannot print out the postage indicium again, and so he or she can request a new postage indicium from the server 103.

The preceding description of exemplary embodiments of the invention with reference to the figures is to be understood as an illustration and by way of an example. The invention is not limited to the embodiments presented.

In conjunction with the printing of postage indicia by an intelligent document, an exemplary embodiment of the present invention is especially not limited to the presented checking steps. On the contrary, the person skilled in the art can see that, within the scope of the invention, other checking steps can be carried out whose results are displayed in the document. Moreover, the invention is by no means limited to the display of results of checking steps that are carried out during the printing of postage indicia. Rather, the person skilled in the art recognizes that the invention can also be used in areas other than the franking of mailpieces.

Thus, in particular, the presence of the program execution environment can be checked in any intelligent document and the result of the checking can be displayed. The intelligent documents can include, for example, intelligent documents containing animated graphics or forms. In particular, an exemplary embodiment of the present invention can be used with forms that are employed in communication with official agencies and that are configured as intelligent documents. On the basis of the checking steps, whose results are displayed with the invention, it is also especially possible to check whether certain mandatory fields of a form have been filled in.

Moreover, an exemplary embodiment of the present invention can also be used for intelligent documents that are protected using the “intelligence” from unauthorized access. In this context, mention should be made, for instance, of texts that can only be displayed and/or printed out if the user is authorized to do so, whereby the authorization of the user is checked, for example, by a query made to the server by the intelligent document via the network 102.

1-17. (canceled)

18. A method for producing an intelligent document comprising a program which, when a precondition has been met, can be executed by a program execution environment, the intelligent document containing contents that can be displayed by a display program, the method comprising:
incorporating a program module into the intelligent document, the program module being configured to create displayable information indicating a result of a checking step in order to check whether the precondition has been met within the intelligent document;
inserting displayable information indicating a negative result of the checking step into the intelligent document; and
transforming, with the program module, the information indicating the negative result of the checking step into displayable information indicating a positive result of the checking step.

19. The method recited in claim 18, comprising using the program module to perform the checking step.

20. The method recited in claim 18, comprising checking whether the program execution environment is available during the checking step.

21. The method recited in claim 18, comprising blocking the display of the displayable information indicating the negative result of the checking step after the intelligent document has been opened.

22. The method recited in claim 18, comprising displaying the displayable information about a result of the checking step once the checking step has been carried out.

23. The method recited in claim 18, comprising:
performing a one-time printing of a postage indicium, and
transmitting the intelligent document from a franking server via a network to a franking client.

24. The method according to claim 23, comprising:
transmitting a message from a user client to the franking server when the postage indicium is printed for the first time; and
logging the printing on the franking server in response to the message.

25. The method according to claim 23, comprising permitting the printing of the postage indicium only if a network connection exists between the franking client and the franking server, and if, on the basis of a query to the franking server, it has been ascertained that that postage indicium had not been printed before.

26. The method recited claim 18, comprising checking whether there is access to a network as part of the checking step.

27. The method recited in claim 18, comprising querying a franking server during the checking step to inquire whether contents of the intelligent document have been printed before.

28. The method recited in claim 18, wherein the program execution environment is a component of the display program.

29. A tangible, machine-readable medium that stores machine-readable instructions that are executable by a computer to produce an intelligent document comprising a program which, when a precondition has been met, can be executed by a program execution environment, the intelligent document containing contents that can be displayed by a display program, the tangible, machine-readable medium comprising:
machine-readable instructions that, when executed by a computer, incorporate a program module into the intelligent document, the program module being configured to create displayable information indicating a result of a checking step in order to check whether the precondition has been met within the intelligent document;
machine-readable instructions that, when executed by a computer, insert displayable information indicating a negative result of the checking step into the intelligent document; and
machine-readable instructions that, when executed by a computer, transform, with the program module, the information indicating the negative result of the checking step into displayable information indicating a positive result of the checking step.

30. An intelligent document, comprising:
a program which, when a precondition has been met, can be executed by means of a program execution environment, said intelligent document containing contents that can be displayed by a display program; and
a program module that is configured to create displayable information indicating the result of a checking step in order to check whether the precondition has been met within the intelligent document, the displayable information being converted by the program module into displayable information indicating a positive result of the checking step; and
displayable information indicating a negative result of the checking step.

31. A device for the production of an intelligent document that provides a function that, when a precondition has been met, can be executed, the intelligent document containing contents that can be displayed by a display program, the device comprising:
means for inserting a program module into the intelligent document, the program module being configured to create displayable information indicating the result of a checking step in order to check whether the precondition has been met within the intelligent document;
means for inserting displayable information indicating a negative result of the checking step into the intelligent document; and
means for transforming the displayable information indicating the negative result of the checking step into information indicating a positive result of the checking step.
